(19) United States
(12) Patent Application Publication
(10) Pub. No.: US 2009/0181342 A1
(43) Pub. Date: Jul. 16, 2009

(54) Tooth Extration Assisting Device

(76) Inventor: Hua-Hong Chien, Taichung (TW)

Correspondence Address: HDLS Patent & Trademark Services, P.O. BOX 220746, CHANTILLY, VA, 20153-0746, US

(21) Appl. No.: 12/014,395

(22) Filed: Jan. 15, 2008

(51) Int. Cl. A61C 1/07

(52) U.S. Cl. 433/119

(57) ABSTRACT

A tooth extraction assisting device includes an ultrasonic machine, an ultrasonic hand piece, and 5 different insert tips that are hook-on to the hand piece. The ultrasonic machine outputs a signal with high frequency oscillation. This high frequency oscillation signal received by the ultrasonic hand piece generates a high frequency vibration of the insert tip. A set of 5 different configuration insert tips was designed for a precision surgical cut at the coronal portion of the periodontal ligament around tooth to be extracted. This device also provides a better visibility at the surgical area with the cavitation effect. With the help of the tooth extraction assisting device dental clinician is able to perform tooth extraction with less chair-time without damaging to the buccal alveolar process which increases the chance of immediate implant placement at the same appointment.

### BACKGROUND OF THE INVENTION

1. Field of the Invention

The present invention relates to an ultrasonic power-driven device, which easily removes hopeless tooth, residual roots or remained tooth structures in the alveolar bone during tooth extraction. This device will assist dental practitioners to performed minimally invasive surgery to remove the tooth structures without damage the alveolar housing, especially the buccal plate, which allowing implant placement at the time of tooth extraction. A method for using this ultrasonic device is also presented.

2. Description of the Background Art

In tradition, the implant was placed into healed edentulous ridges where an appropriate bone width is available to support the fixture. However, several studies have shown that the delayed approach results in labial bone loss with significant horizontal deficiency in over 50% of cases, which presents a clinical problem especially in the esthetic zone, and subsequently requiring hard and soft tissue grafting prior to implant placement. In order to avoid this problem, it is desirable to provide treatment that aims at preservation of the natural tissue contours during tooth extraction to ensure optimal implant placement and esthetic outcome.

The problem one has to face in order to carry out immediate implant placement after tooth extraction is to destroy or remove as little bone structure as possible during tooth extraction. In conventional tooth extraction, an extraction forceps or elevator is used to separate the tooth from the alveolar socket by a bucco-lingual/mesio-distal rotation force or a wedging force, respectively. These methods more or less damage the structure of alveolar bone housing, especially on the buccal plate of the extraction socket. The buccal cortical plate around the upper front teeth is generally a very thin board of bone due to root prominence. Removing the tooth or root structure in this area using conventional methods often smashed this thin cortical bone, resulting in immediate implant placement nearly impossible.

A hand-operated instrument, namely Periotome®, was recently developed for atraumatic tooth extraction to minimize damage to alveolar process. The Periotome® is designed to sever the subcrestal attachment apparatus to allow tooth escape the alveolar housing occlusally without destruction to the supporting bone. With the use of Periotome®, the clinician is able to extract intact teeth or removal of retained root fragments without distortion or damage to the alveolar bone, resulting in higher chance of immediate implant placement. Although, Periotome® has been reported with several advantages as compared to a traditional extraction, its clinical application appears to have the following limitations.
1. A Periotome® is being used with light-to-moderate apical pressure to complete rupture of the gingival fibers and further down to sever the periodontal ligaments. It is necessary to apply Periotome® repeatedly in a mesio-distal direction on the whole circumference of the root. This procedure is a time consuming task, especially when a failed endodontically treated tooth is involved.
2. It is important to ensure that the tip of the Periotome® blade does not slide out of the alveolar ridge in order to avoid laceration on gingival tissue. It will be more difficult to apply the Periotome® when molar tooth extraction is involved due to the limitation of patient's mouth opening.
3. A mallet may be required to push further down of the Periotome® toward the root apex, especially when a retained root fragment needed to be removed. The use of the mallet may increase the risk of distortion or damage to the alveolar bone.
4. Periotome® is designed in a thin plane shape which may limit its entrance into the periodontal ligament space of teeth with curvature roots. As a result, it may further prevent Periotome® reaching toward the root apex without the aid of a mallet. In this case, additional elevation may be required because significant tooth mobility is not achieved. This also increases the risk of distortion or damage to the alveolar process.
5. Tooth becomes more fragile after endodontic therapy, which may demand more caution when it needs to be removed. Removal of a retained root fragment requires significant work and is also time consuming task, especially when a Periotome® is applied.

Hereby, the inventor of the present invention did extensive research on the above-mentioned problems in regards to tooth extraction following by immediate implant placement. As a result of long time effort in research and experiment, a tooth extraction assisting device is developed to perform a speedy tooth extraction with minimal damage to alveolar bones for immediate implant placement.

### SUMMARY OF THE INVENTION

The main objective of the present invention is to provide a tooth extraction assisting device utilizing an ultrasonic power to facilitate quick tooth extraction with minimal damage to the surrounding alveolar bones for immediate implant placement.

The present invention mainly includes 5 insert tips with specific configuration matching the curvature of the roots, an ultrasonic unit for output of a high frequency oscillating signal, and one hand piece on which the insert tip can be attached to. The insert tip is driven by the ultrasonic power and creates the high frequency vibration, making itself suitable to sever the dentogingival junction as well as the coronal portion of the periodontal ligament around the tooth to be extracted.

When compare with traditional tools in tooth extraction, the present device works more efficiency on the removal of a tooth or a retained root structure with minimal damage to the alveolar process. It has the following advantages during the course of tooth extraction.
(1) The configuration (shape and angulations) of the insert tip is designed to match the curvature of the root and hence make it easier to reach the coronal portion of the periodontal ligament around tooth need to be extracted.
(2) It is convenient, less chair-time, and more efficient to sever the coronal portion of periodontal ligaments by utilizing the benefit of ultrasonic vibration.
(3) Not only does the insert tip be capable of cutting periodontal ligaments, but it also serves to loosen the tooth by ultrasonic vibration. As a result, the tooth can be quite loose and fairly easy to be detached by using an extraction forceps or elevator. The efficiency of the insert tip in loosening a root structure is quite conspicuous when a fracture root was encountered. The fracture root can be easily removed with minimal destruction on the buccal alveolar process.
(4) The normal saline cavitation not only provides effective cooling to the insert tip but also creates a clean operation filed at the surgical site.
(5) When comparing with either a traditional method or hand operated Periotome® in tooth removal, the present invention can provide a quicker, labor-saving, and clear visibility at surgical site with minimal damage to the buccal alveolar process.

Other advantages and novel features are demonstrated in the following description of preferred embodiment with the attached drawings.

### BRIEF DESCRIPTION OF THE DRAWINGS

FIG. 1 is a perspective view of a tooth extraction assisting device in accordance with a preferred embodiment of the present invention;

FIG. 2 is a lateral view of insert No. 1 for extraction of anterior teeth.

FIG. 3 is a frontal view of FIG. 2.

FIG. 4 is a top view of FIG. 2.

FIG. 5 is a lateral view of insert No. 2 for use on a labial/buccal or lingual/palatal side of a posterior tooth.

FIG. 6 is a frontal view of FIG. 5.

FIG. 7 is a top view of FIG. 5.

FIG. 8 is a lateral view of insert No. 3 for use on a labial/buccal or lingual/palatal side of a posterior tooth.

FIG. 9 is a frontal view of FIG. 8.

FIG. 10 is a top view of FIG. 8.

FIG. 11 is a lateral view of insert No. 4 for use on a mesial side of a posterior tooth.

FIG. 12 is a frontal view of FIG. 11.

FIG. 13 is a top view of FIG. 11.

FIG. 14 is a lateral view of insert No. 5 for use on a distal side of a posterior tooth.

FIG. 15 is a frontal view of FIG. 14.

FIG. 16 is a top view of FIG. 14.

FIG. 17 is schematic view of a tooth extraction assisting device for use on a mesial side of a tooth in operation in accordance with a preferred embodiment of the present invention.

### DETAILED DESCRIPTION OF THE INVENTION

According to the idea of the present invention, ultrasonic oscillation energy is applied to an insert tip in accordance with tooth root shape to initiate a high frequency vibration of the insert tip. By using these specially designed insert tips with high frequency vibration, it is simple and labor-saving to sever gingival fibers and periodontal ligaments, which subsequently increase tooth mobility for ease of tooth extraction with minimal distortion or damage to the alveolar bone.

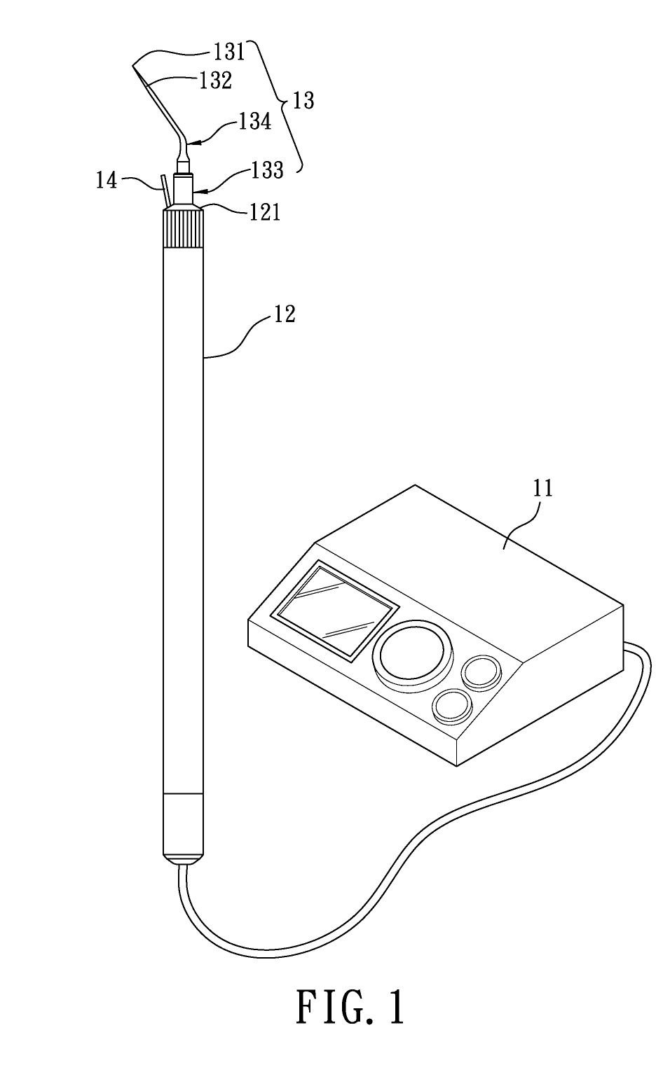

Referring to FIG. 1, the a tooth extraction assisting device in accordance with a preferred embodiment of the present invention mainly includes an ultrasonic machine (11), an ultrasonic hand piece (12), an insert tip (13) in accordance with the root shape of a tooth, and a normal saline supply apparatus (not shown). In the preferred embodiment, the normal saline supply apparatus has a transport pipe (14) for cooling of the insert tip (13) during tooth extraction. The transport pipe (14) is connected to the ultrasonic hand piece (12). The ultrasonic machine (11) mainly provides an output signal with high frequency oscillation for the ultrasonic hand piece (12), which generates a high frequency vibration of the insert tip. The insert tip is detachable and mounted to the holder (121) of the ultrasonic hand piece (12). The insert tip (13) has a sharp tip edge (131) for incision in a vertical direction, and at least one side edge (132) for scraping in a horizontal direction.

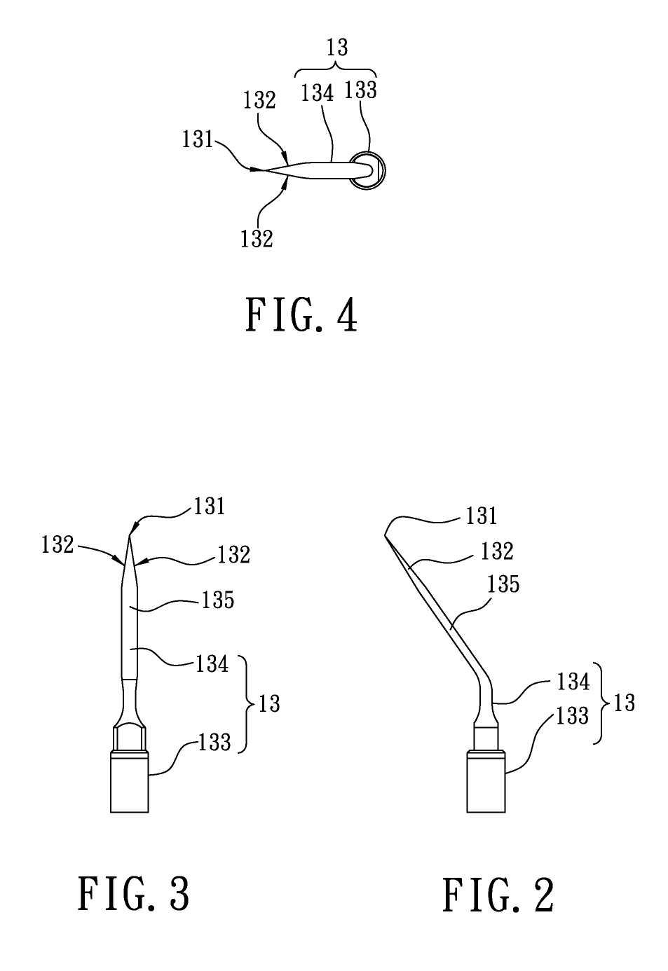

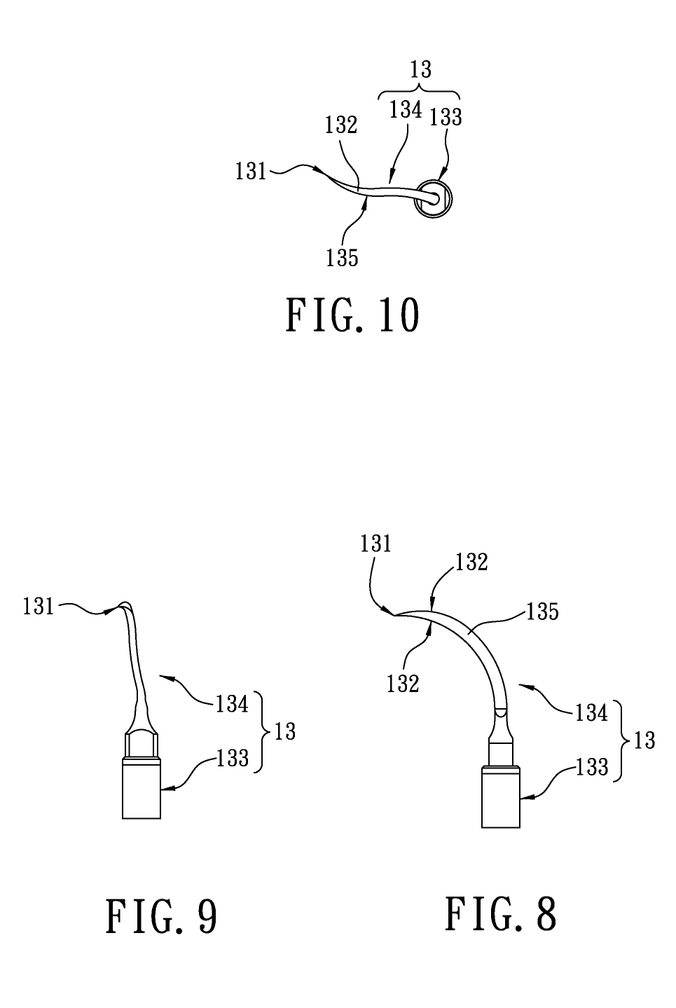

Referring to FIGS. 2 to 16, in the present embodiment, the insert tips (13) have different degrees of angulations which are specifically fitted to all the root shape and they are all detachably mounted to the ultrasonic hand piece (12). The configuration and angulation of each insert (13) are designed to match with the configuration of a corresponding tooth. The five different inserts (13) with specific configuration and angulation are hereinafter described in detail.

FIGS. 2 to 4 show different views of the first insert tip (13), which works very well on both labial and lingual surfaces of anterior teeth. The first insert tip (13) includes a handle (133) and a body (134) thereon. The body (134) is composed of a board (135) with a double side edge (132) and a tip edge (131). The body (134) extends from the handle (133) by a length, and then tilts forward with a specific angle. The handle (133) is attached to the insert tip holder (121).

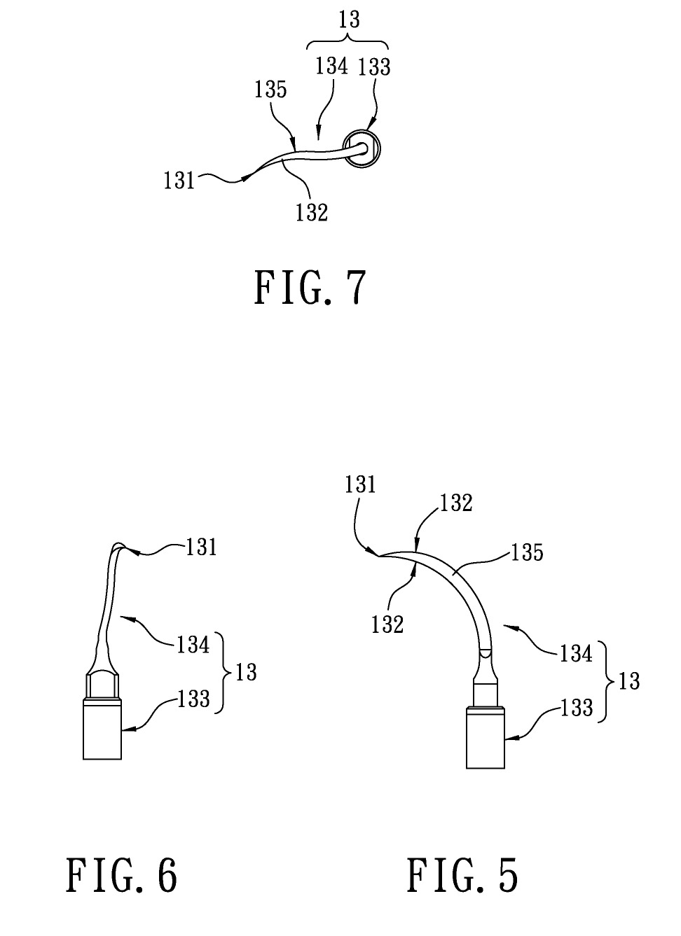

FIGS. 5 to 7 and FIGS. 8 to 10 illustrate views from different angle of the second and third insert tips (13), respectively, which work very well on both buccal and lingual surfaces of posterior dentitions. The second and third insert tips (13) also include a handle (133) and a body (134) thereon. The body (134) contains a curved board (135), a double side edge (132), and a tip edge (131). The body (134) extends from the handle (133) by a length and tilts toward either right or left side to form a curved board (135) with a double side edge (132), as shown in FIGS. 5 to 7 and 8 to 10, respectively. The handle (133) is attached to the insert tip holder (121).

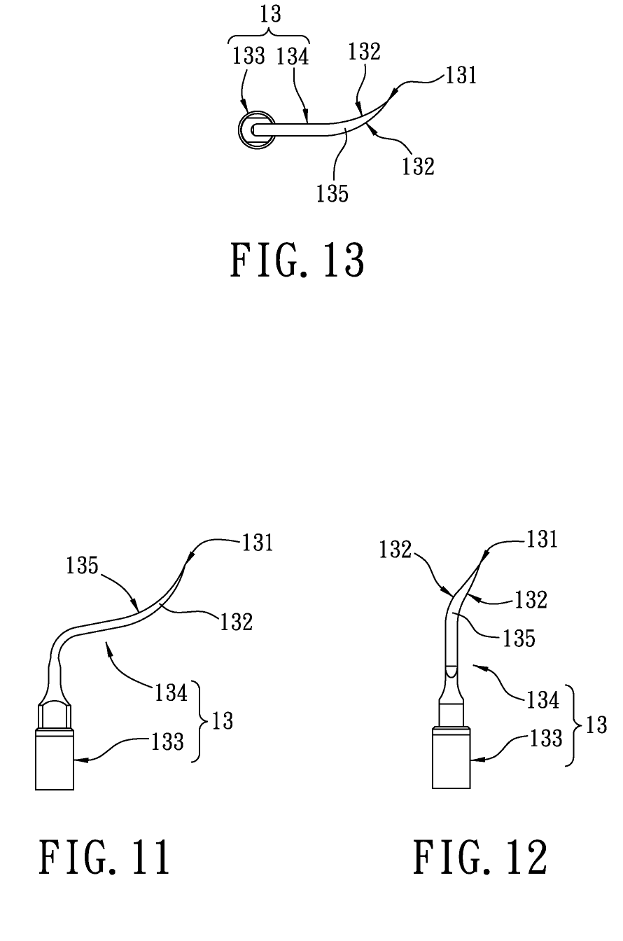

FIGS. 11 to 13 demonstrate different views of the fourth insert tip (13), which adapts very well on the mesial surface of the posterior dentitions. The fourth insert tip (13) has a handle (133) and a body (134) thereon. The body (134) contains a curved board (135), a double side edge (132) and a tip edge (131) located at the front portion of the insert. The body (134) extends from the handle (133) by a length, and is then tilts with a specific angulation. The handle (133) is attached to the insert tip holder (121).

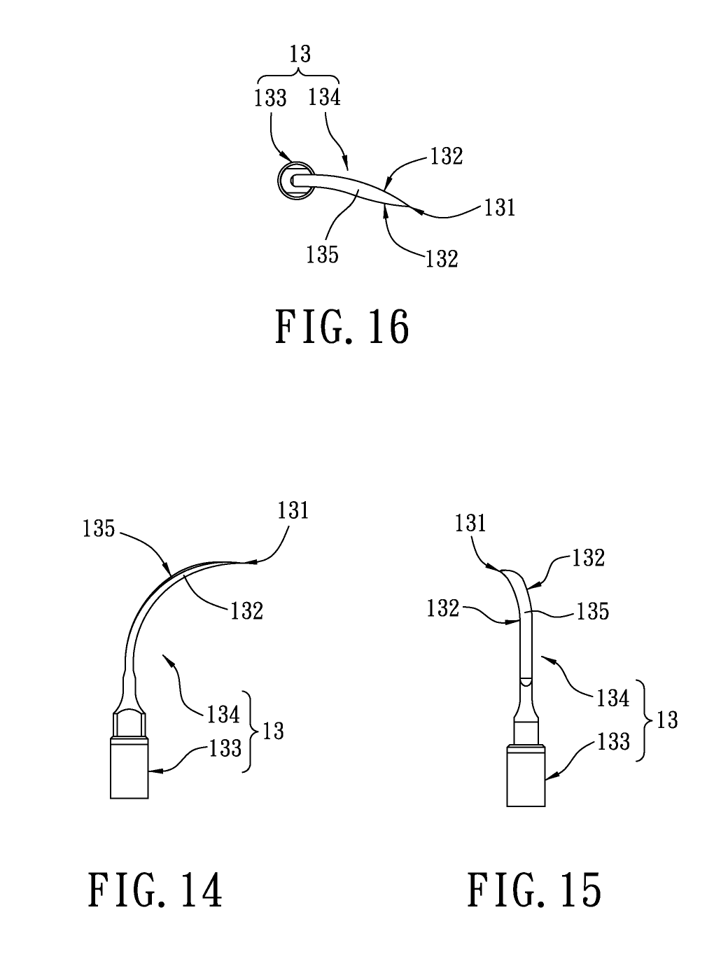

FIGS. 14 to 16 illustrate different views of the fifth insert tip (13), which is corresponding well to the distal surface of posterior teeth. The fifth insert tip (13) also contains a handle (133) and a body (134) thereon. The body (134) has a board (135), a double side edge (132) located at two opposing sides of the board (135), and a tip edge (131) at the front portion of the board (135). The body (134) is bent to form the curved board 135 thereon, the front edge 131 of the insert body 134 is curved either leftwards or rightwards to be arc-shaped.

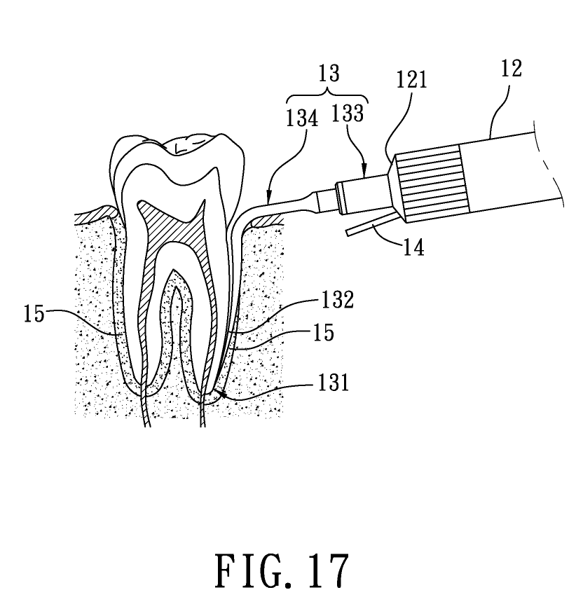

FIG. 17 shows a working status schematic view of the apparatus to achieve atraumatic tooth extraction using the fourth insert tip, which applied to the mesial surface of a posterior tooth. The insert tip (13) has a front edge (131) to sever the dentogingival junction as well as the coronal portion of the periodontal ligaments. Therefore, a less traumatic force can be generated to the buccal alveolar process of the tooth to be extracted.

According to the idea of the present invention, ultrasonic oscillation energy is applied to an insert tip in accordance with the root morphology to generate precision surgical cut at the coronal portion of the periodontal ligament, as well as to create a better visibility at the surgical area with the cavitation effect. With the help of the tooth extraction assisting device, dental clinician can perform tooth extraction with less chair-time without damaging to the buccal alveolar process which increases the chance of immediate implant placement at the same time.

While the present invention has been illustrated by the description of preferred embodiments thereof, and while the preferred embodiments have been described in considerable detail, it is not intended to restrict or in any way limit the scope of the appended claims to such details. Additional advantages and modifications within the spirit and scope of the present invention will readily appear to those skilled in the art. Therefore, the present invention is not limited to the specific details and illustrative examples shown and described.

What we claimed are as follows:

1. A tooth extraction assisting device comprising: an ultrasonic unit for output of a high frequency oscillating signal; an ultrasonic hand piece that receives the high frequency oscillating signal and converts the signal to high frequency vibration; and a set of five insert tips with specific angulation, wherein the insert tips consist of a front and double side edge which allows the insert tips easily and quickly sever a dentogingival junction as well as a coronal portion of periodontal ligaments.

2. The tooth extraction assisting device as described in claim 1, comprising the five insert tips with specific configuration and angulation, and a micro-vibration of the insert tip providing a precise cutting at the coronal portion of the periodontal ligaments loosing a tooth at a socket for easy extraction.

3. The tooth extraction assisting device as described in claim 1, wherein first insert tip adapts very well on both labial and lingual surfaces of anterior teeth allowing a precise cutting at the coronal portion of the periodontal ligaments, second and third insert tips, which are mirror image to each other, fit very well on both buccal and lingual surfaces of posterior dentitions, and fourth and fifth insert tips adapt very well on a mesial and distal surface of the posterior dentitions, respectively, each insert tip including a handle and a body thereon, and the body including a board with a double side edge and a tip edge, the body extending from the handle by a length, and then tilting forward with a specific angle, and a handle being attached to the insert tip holder.

4. The tooth extraction assisting device as described in claim 1, further comprising a normal saline supply apparatus having a transport pipe corresponding to an insert tip to provide normal saline cavitation for better intra-operative visibility with a blood-free surgical site.
